(19) United States
(12) Patent Application Publication
(10) Pub. No.: US 2015/0331839 A1
(43) Pub. Date: Nov. 19, 2015

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Hiroshi TODOROKI, Kanagawa (JP)

(73) Assignee: FUJI XEROX CO., LTD., Tokyo (JP)

(21) Appl. No.: 14/576,696

(22) Filed: Dec. 19, 2014

(30) Foreign Application Priority Data
May 19, 2014 (JP) 2014-103712

(51) Int. Cl. G06F 17/22; G06F 17/30

(52) U.S. Cl. CPC G06F 17/2247; G06F 17/30864

(57) ABSTRACT

An information processing apparatus includes a holding unit and a transmission unit. The holding unit holds information for use during transmission including transmission destination information, item information, and correspondence information. The transmission destination information and the item information are acquired from page display information for displaying a page and transmitting document information at a designated location to a transmission destination determined in advance together with a character string or a value input in correspondence with an item to be displayed on the page. The transmission destination information represents the transmission destination. The item information represents the item. The correspondence information pertains to the character string or the value corresponding to the item. The transmission unit transmits the document information to the transmission destination together with the character string or the value correlated with the item on the basis of the information for use during transmission.

### CROSS-REFERENCE TO RELATED APPLICATIONS

This application is based on and claims priority under 35 USC 119 from Japanese Patent Application No. 2014-103712 filed May 19, 2014.

### BACKGROUND

1. Technical Field

The present invention relates to an information processing apparatus and a non-transitory computer readable medium.

2. Summary

An aspect of the present invention provides an information processing apparatus including: an a holding unit that holds information for use during transmission including transmission destination information, item information, and correspondence information, the transmission destination information and the item information being acquired from page display information for displaying a page and transmitting document information at a designated location to a transmission destination determined in advance together with a character string or a value input in correspondence with an item to be displayed on the page, the transmission destination information representing the transmission destination, the item information representing the item, and the correspondence information pertaining to the character string or the value corresponding to the item; and a transmission unit that transmits the document information to the transmission destination together with the character string or the value correlated with the item on a basis of the information for use during transmission.

### BRIEF DESCRIPTION OF THE DRAWINGS

An exemplary embodiment of the present invention will be described in detail based on the following figures, wherein:

FIG. 1 illustrates an example of the configuration of an information processing apparatus;

FIG. 2 illustrates an example of the functional configuration of a controller;

FIG. 3 illustrates a display example of a page acquired by a page acquisition section;

FIG. 4 illustrates an example of transmission and reception of data based on the page;

FIG. 5 illustrates an example of transmission and reception of data based on the page;

FIG. 6 illustrates a display example of a setting screen configured by a setting screen configuration section;

FIG. 7 illustrates an example of the content of a table used to configure the setting screen;

FIG. 8 illustrates an example of the content of a job flow generated by a job flow conversion section;

FIG. 9 illustrates an example of the content of a distribution job included in the job flow;

FIG. 10 illustrates an example of transmission of data based on the job flow; and

FIG. 11 illustrates an example of transmission of data based on the job flow.

### DETAILED DESCRIPTION

An exemplary embodiment of the present invention will be described below with reference to the drawings.

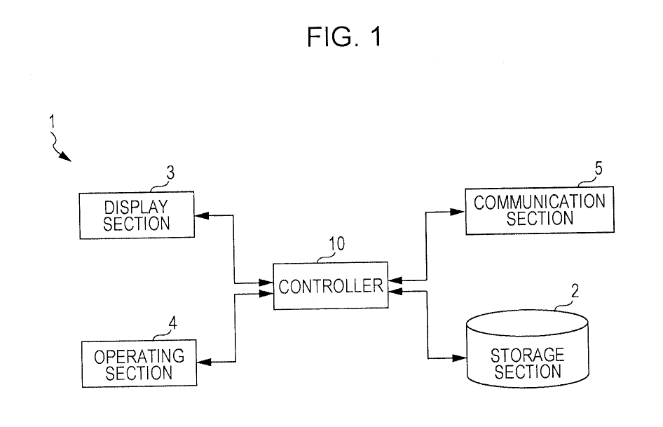

FIG. 1 illustrates an example of the configuration of an information processing apparatus 1. The information processing apparatus 1 includes a storage section 2, a display section 3, an operating section 4, a communication section 5, and a controller 10.

The storage section 2 is a hard disk drive (HDD) or a solid state drive (SSD), for example. The storage section 2 stores a database that is accessible by the controller 10. The database may be stored in a device different from the information processing apparatus 1.

The display section 3 is a liquid-crystal display panel, for example. The operating section 4 is a keyboard or a mouse, for example. The communication section 5 is a device that communicates with other devices through a wire or wirelessly, for example.

The controller 10 includes a computing section such as a central processing unit (CPU) and a storage section such as a random access memory (RAM), for example. The controller 10 processes information in accordance with a program. The program may be provided from a computer-readable information recording medium such as a CD-ROM, or may be provided via a communication line such as the Internet.

The information processing apparatus 1 may include a printer section that forms an image on a surface of a medium in accordance with an instruction from the controller 10, a scanner section that outputs image data read from a surface of a medium to the controller 10, and so forth.

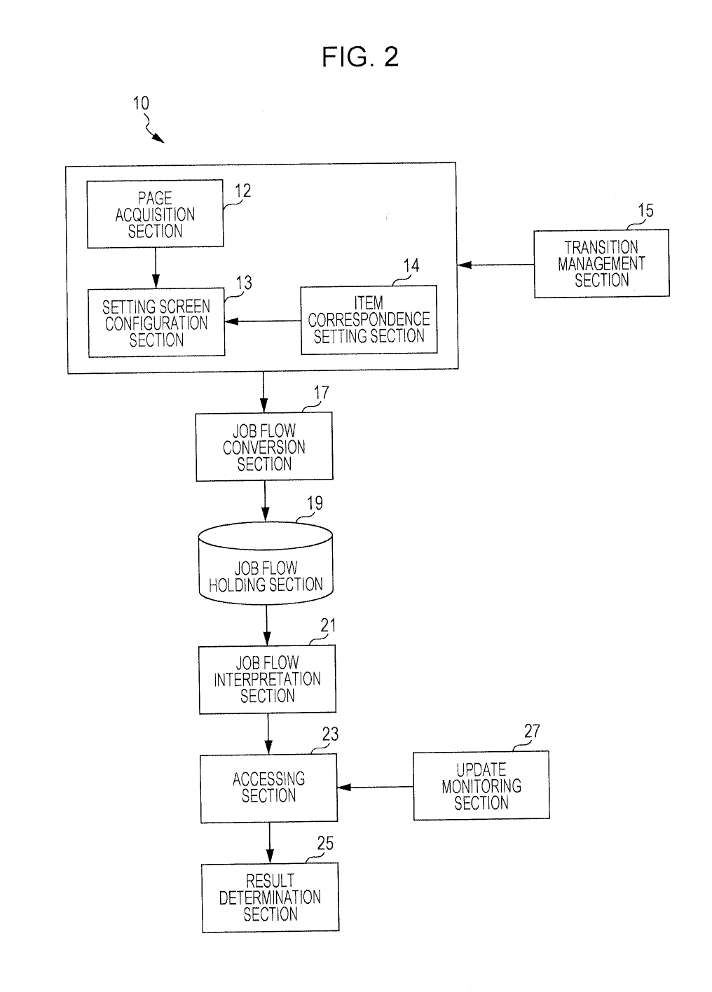

FIG. 2 illustrates an example of the functional configuration of the controller 10. Various sections included in the controller 10 are implemented by the controller 10 executing a program. It should be noted, however, that a job flow holding section 19 is implemented by the storage section 2.

The controller 10 includes, as components that generate a job flow, a page acquisition section 12, a setting screen configuration section 13, an item correspondence setting section 14, a transition management section 15, and a job flow conversion section 17.

In addition, the controller 10 includes, as components that execute a job flow, a job flow interpretation section 21, an accessing section 23, a result determination section 25, and an update monitoring section 27. The job flow is an example of information for use during transmission.

The components that generate a job flow and the components that execute a job flow may be included in separate devices.

The page acquisition section 12 acquires a Hyper Text Markup Language (HTML) file, the location of which is designated by a user, from an external system. The HTML file is an example of page display information. The HTML file acquired by the page acquisition section 12 will be described below.

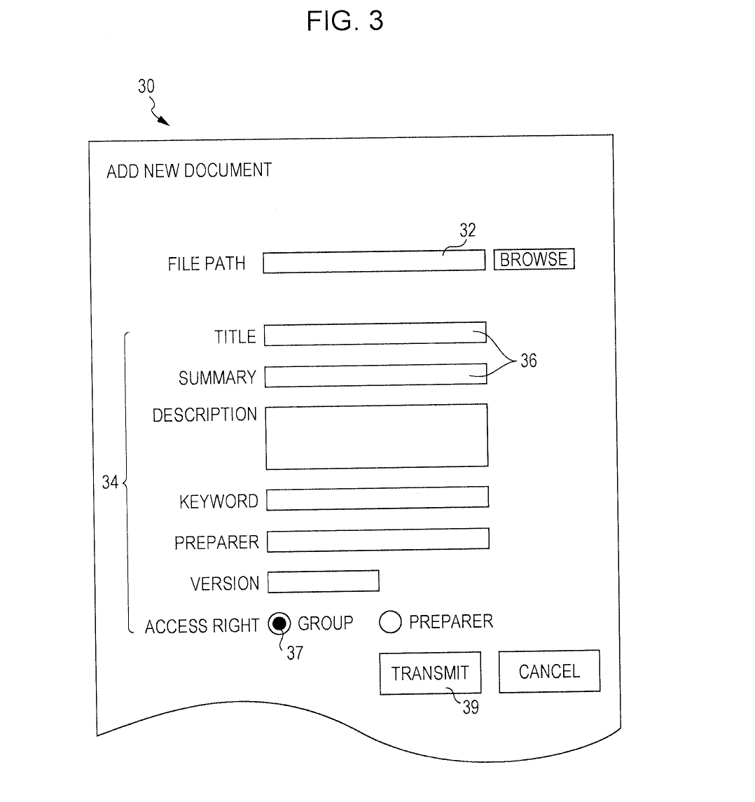

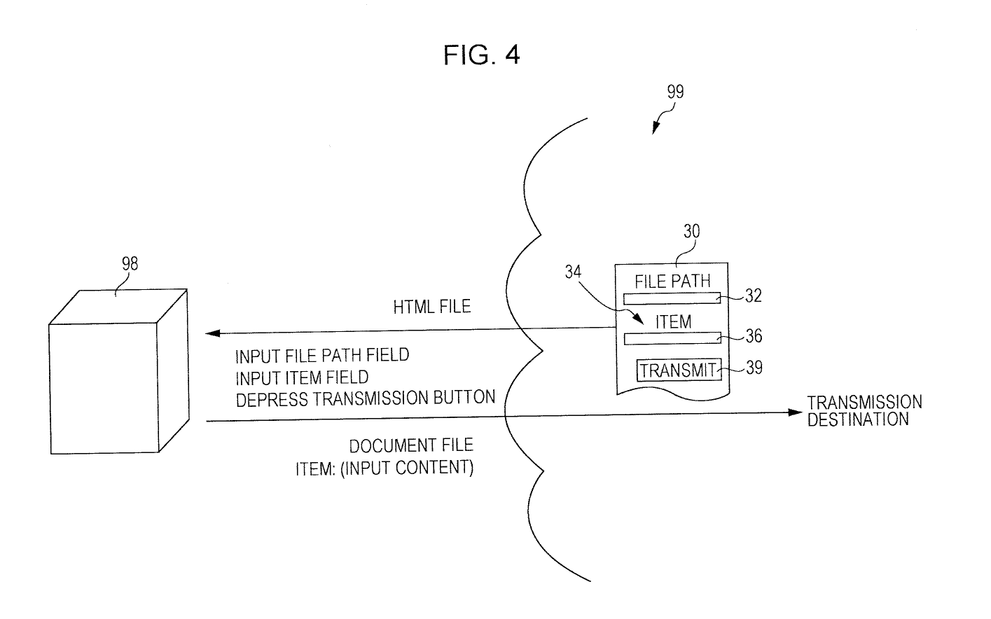

FIGS. 3 and 4 illustrate a page 30 displayed on the basis of an HTML file. The drawings illustrate a display example of the page 30 and an example of transmission and reception of data based on the page 30, and do not illustrate acquisition by the page acquisition section 12.

The page 30 displayed on the basis of an HTML file is used to upload a document file to an external system 99. The external system 99 provides an online storage service, for example, and holds an HTML file for displaying the page 30.

As illustrated in FIG. 3, the page 30 is provided with a file path input field 32, item indications 34, item correspondence input fields 36, item correspondence select fields 37, and a transmission button 39. A character string that represents the location of a document file to be transmitted is input to the file path input field 32.

The item indications 34 represent items to be added to the document file, and indicate the name or the like of the items, for example. Examples of the items include a title, a summary, and a description as illustrated in FIG. 3. The item correspondence input fields 36 and the item correspondence select fields 37 are provided in correspondence with the items represented by the item indications 34. A character string to be correlated with the item is input to the item correspondence input fields 36. The item correspondence select fields 37 are radio buttons, for example, and allow selection of a single value from plural values related to the items.

The transmission button 39 is used to transmit the document file to a transmission destination determined in advance. Specifically, when the transmission button 39 is depressed, a document file, the location of which is specified by a character string input to the file path input field 32, is transmitted to the transmission destination determined in advance together with the character strings input to the item correspondence input fields 36 correlated with the items represented by the item indications 34 and the values selected using the item correspondence select fields 37.

As illustrated in FIG. 4, the external system 99 holds an HTML file for displaying the page 30, and transmits the HTML file to an information processing apparatus 98. FIG. 4 illustrates an example of transmission and reception of data based on the page 30, and the information processing apparatus 98 is different from the information processing apparatus 1 discussed above.

A user of the information processing apparatus 98 operates an operating section such as a keyboard or a mouse to input a character string that represents the location of a document file to the file path input field 32, input character strings correlated with the items indicated by the item indications 34 to the item correspondence input fields 36, and thereafter depress a transmission button 39.

When the transmission button 39 is depressed, the information processing apparatus 98 transmits a document file, the location of which is specified by the character string input to the file path input field 32, to the transmission destination determined in advance in the external system 99 together with the character strings input to the item correspondence input fields 36 correlated with the items represented by the item indications 34.

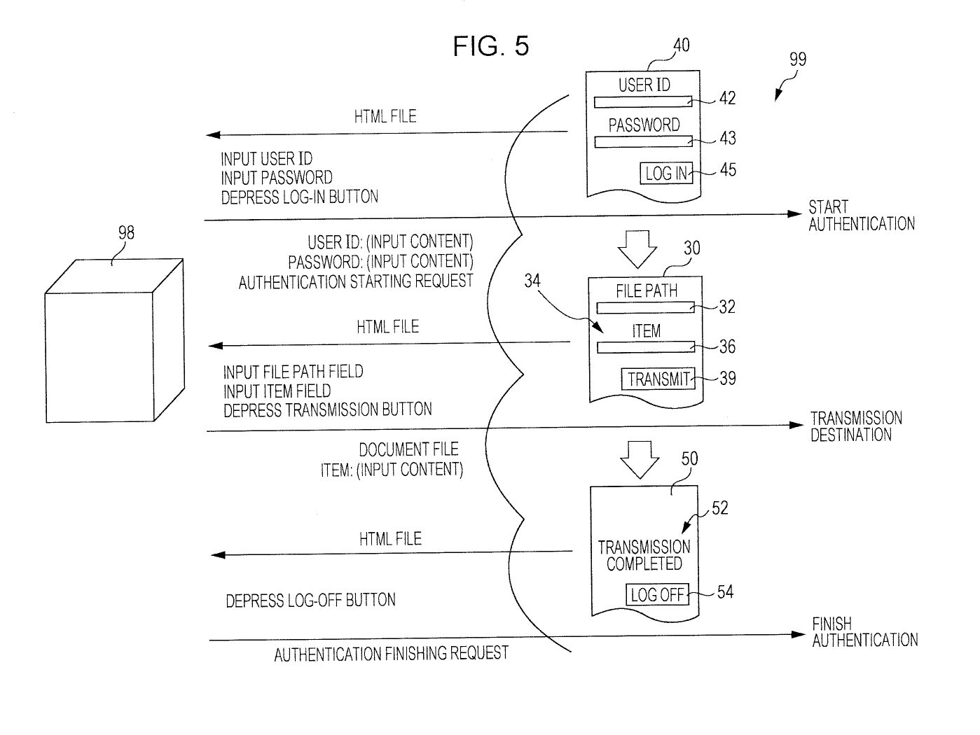

FIG. 5 illustrates an example of transmission and reception of data based on pages 30, 40, and 50 including the page 30 discussed above. A transition may be made from the page 40 to the page 30. A transition may be made from the page 30 to the page 50.

The page 40 is used to start user authentication. When user authentication is started, a transition is made from the page 40 to the page 30. The page 40 is provided with a user ID input field 41, a password input field 42, and a log-in button 45. A character string that represents a user ID is input to the user ID input field 41. A character string that represents a password is input to the password input field 42.

The log-in button 45 is used to request start of user authentication. Specifically, when the log-in button 45 is depressed, an authentication starting request, the character string input to the user ID input field 41, and the character string input to the password input field 42 are transmitted to the transmission destination determined in advance in the external system 99.

The page 50 is used to finish user authentication. When transmission of a document file is completed, a transition is made from the page 30 to the page 50. The page 50 is provided with a transmission complete message 52 and a log-off button 54. The transmission complete message 52 indicates that transmission of the document file is completed.

The log-off button 54 is used to request finish of user authentication. Specifically, when the log-off button 54 is depressed, an authentication finishing request is transmitted to the transmission destination determined in advance in the external system 99.

Returning to the description of FIG. 2, the page acquisition section 12 acquires an HTML file for displaying the page 30 discussed above from the external system 99. In the case where the page 30 involves a transition, the page acquisition section 12 may further acquire an HTML file for displaying the pages 40 and 50 discussed above.

The setting screen configuration section 13 analyzes the HTML file acquired by the page acquisition section 12, and extracts information to be used for transmission of the document file. Specifically, the setting screen configuration section 13 analyzes the HTML file for displaying the page 30, and extracts transmission destination information that represents the transmission destination to which the document file is to be transmitted and item information that represents the items indicated by the item indications 34 (which is a function as an example of an acquisition unit). In the case of HTML files, the transmission destination information and the item information may be extracted from the content of form tags, for example.

Further, the setting screen configuration section 13 configures a setting screen that uses the page 30 on the basis of the information extracted by analyzing the HTML file. The setting screen is a page for generating correspondence information pertaining to the character string or the value corresponding to the items indicated by the item indications 34.

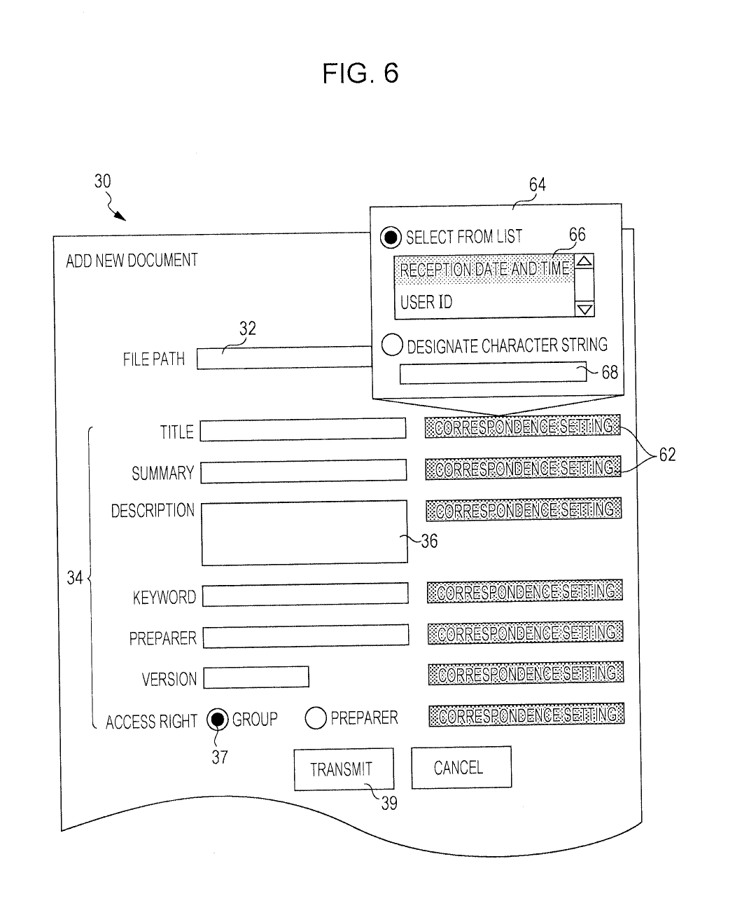

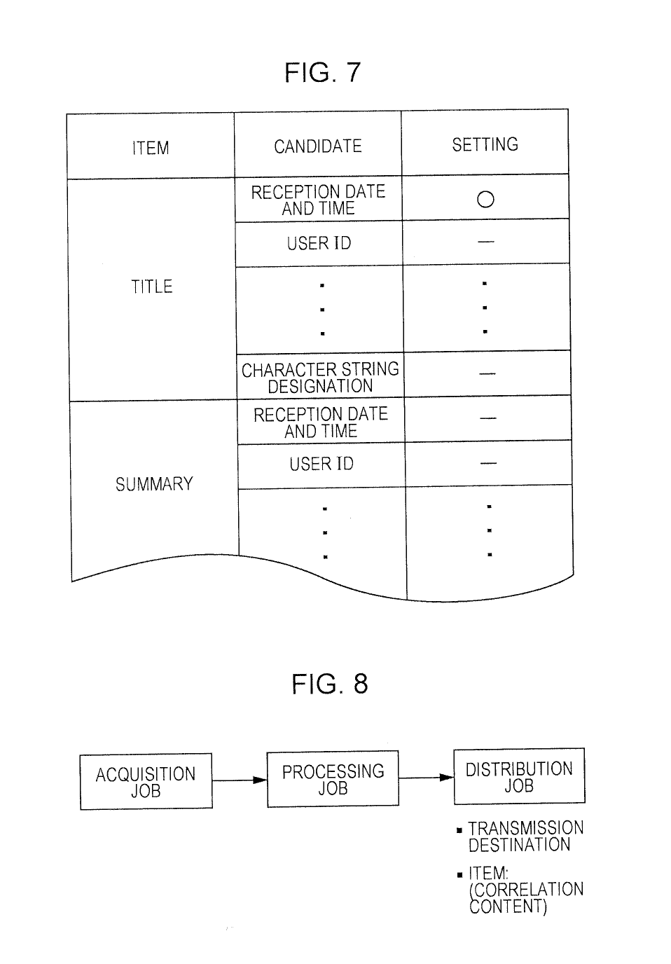

FIG. 6 illustrates a display example of the setting screen configured by the setting screen configuration section 13. FIG. 7 illustrates an example of the content of a table used to configure the setting screen. The setting screen is configured using the page 30. A correspondence setting button 62 is provided in the vicinity of each of the item correspondence input fields 36 and the item correspondence select fields 37.

When the correspondence setting button 62 is depressed, a correspondence setting window 64 that assists generation of correspondence information pertaining to the item for which the correspondence setting button 62 is provided is displayed on the setting screen. The correspondence setting window 64 is an example of a generation assist region. The correspondence setting window 64 includes an item correspondence select field 66 and an item correspondence input field 68.

The item correspondence select field 66 displays plural candidates to be possibly correlated with the item for which the correspondence setting button 62 is provided. The user operates the operating section 4 to select one of the plural candidates. The candidates represent the type of the character string or the value added in advance to the document file, for example. In the case where a “reception date and time” is selected, a character string that represents the reception date and time added in advance to the document file is used as the character string correlated with the item when a job flow to be discussed later is executed.

The item correspondence input field 68 is an input field for receiving input of a character string to be correlated with the item for which the correspondence setting button 62 is provided. The user operates the operating section 4 to input a desired character string to the item correspondence input field 68.

The correspondence setting buttons 62 and region display information for displaying the correspondence setting window 64 on the page 30 are written in a script language, for example, and embedded in the HTML file for displaying the page 30 (which is a function as an example of an addition unit).

Returning to the description of FIG. 2, the item correspondence setting section 14 generates correspondence information pertaining to the item for which the correspondence setting button 62 is provided in the setting screen discussed above on the basis of an operation of the operating section 4 by the user (which is a function as an example of a first generation unit). Specifically, correspondence information is generated when one of the candidates is selected in the item correspondence select field 66, or a character string is input to the item correspondence input field 68, in the correspondence setting window 64 displayed as the correspondence setting button 62 is depressed.

The transition management section 15 holds transition information to be transmitted to the external system 99 in accordance with the HTML file for displaying the pages 40 and 50 in the case where the page 30 involves a transition as illustrated in FIG. 5 discussed above.

Examples of the transition information include a character string correlated as the user ID and a character string correlated as the password. Such character strings are generated by an operation of the operating section 4 by the user, for example. Examples of the transition information also include an authentication starting request and an authentication finishing request. Such requests are acquired by analyzing an HTML file, for example.

The job flow conversion section 17 prepares definition information on a job flow on the basis of information obtained from the setting screen configuration section 13, the item correspondence setting section 14, and the transition management section 15 discussed above (which is a function as an example of a second generation unit). The job flow holding section 19 holds the prepared definition information on the job flow (which is a function as an example of a holding unit).

FIG. 8 illustrates an example of the content of the job flow generated by the job flow conversion section 17. The job flow is a series of jobs to be executed for a document file. The definition information on the job flow includes definition information that represents the content of each of the plural jobs, and order information that represents the order in which such jobs are executed.

In an acquisition job executed in the first step, a document file is acquired from a designated external device or storage location, for example. In a processing job executed in the second step, the document file is processed through a designated process such as resolution conversion or noise removal, for example. In a distribution job executed in the third step, the document file is transmitted to a designated transmission destination, for example.

The definition information on the distribution job includes the transmission destination information that represents the transmission destination to which the document file is to be transmitted and the item information that represents the items indicated by the item indications 34, the transmission destination information and the item information being obtained by analyzing the HTML file for displaying the page 30 (see FIGS. 3 and 4). The definition information on the distribution job further includes correspondence information pertaining to the character string or the value corresponding to the items set in the setting screen (see FIGS. 6 and 7).

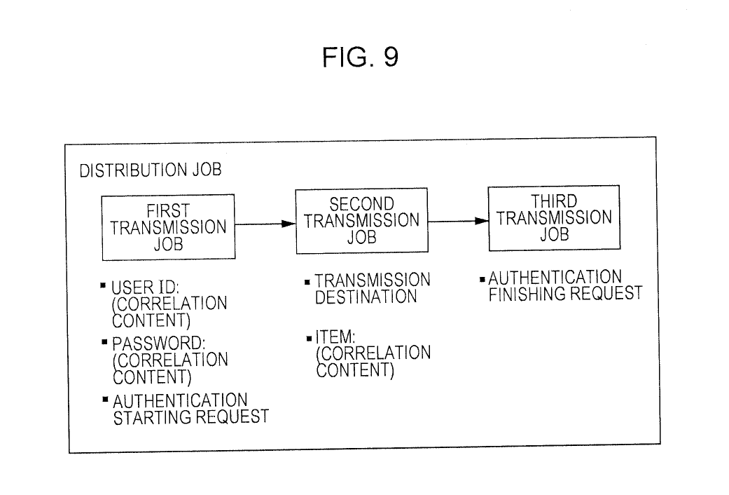

In the case where the page 30 involves a transition as illustrated in FIG. 5 discussed above, the distribution job may include plural transmission jobs to be executed in order as illustrated in FIG. 9. The definition information on the distribution job includes definition information that represents the content of each of the plural transmission jobs, and order information that represents the order in which such transmission jobs are executed.

The definition information on a first transmission job includes information on a character string correlated as the user ID, information on a character string correlated as the password, and information for transmitting an authentication starting request. The definition information on a second transmission job includes transmission destination information, item information, and correspondence information as with the distribution job illustrated in FIG. 8 discussed above. The definition information on a third transmission job includes information for transmitting an authentication finishing request.

Returning to the description of FIG. 2, the job flow interpretation section 21 executes the job flow designated by the user on the basis of the definition information on the job flow read from the job flow holding section 19. The accessing section 23 transmits the document file to the designated transmission destination when the distribution job included in the job flow is executed (which is a function as an example of a transmission unit).

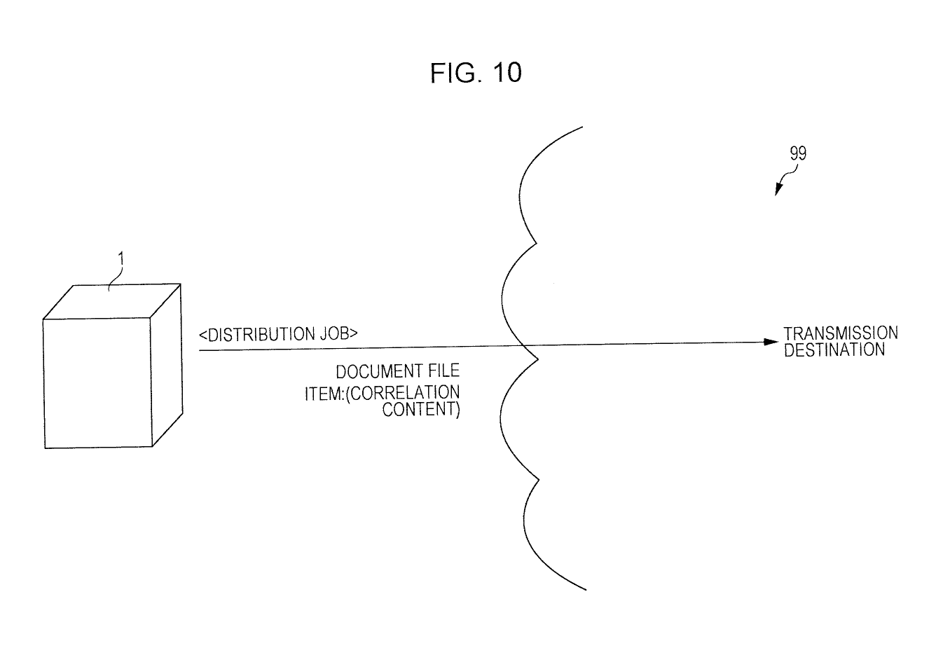

FIG. 10 illustrates an example of transmission of data based on the job flow. When the distribution job included in the job flow is executed, the information processing apparatus 1 transmits the designated document file to the transmission destination specified by the transmission destination information together with the character string or the value correlated with the items specified by the item information and the correspondence information. This enables the information processing apparatus 1 to transmit a document file etc. to the external system 99 as in the case illustrated in FIG. 4 discussed above.

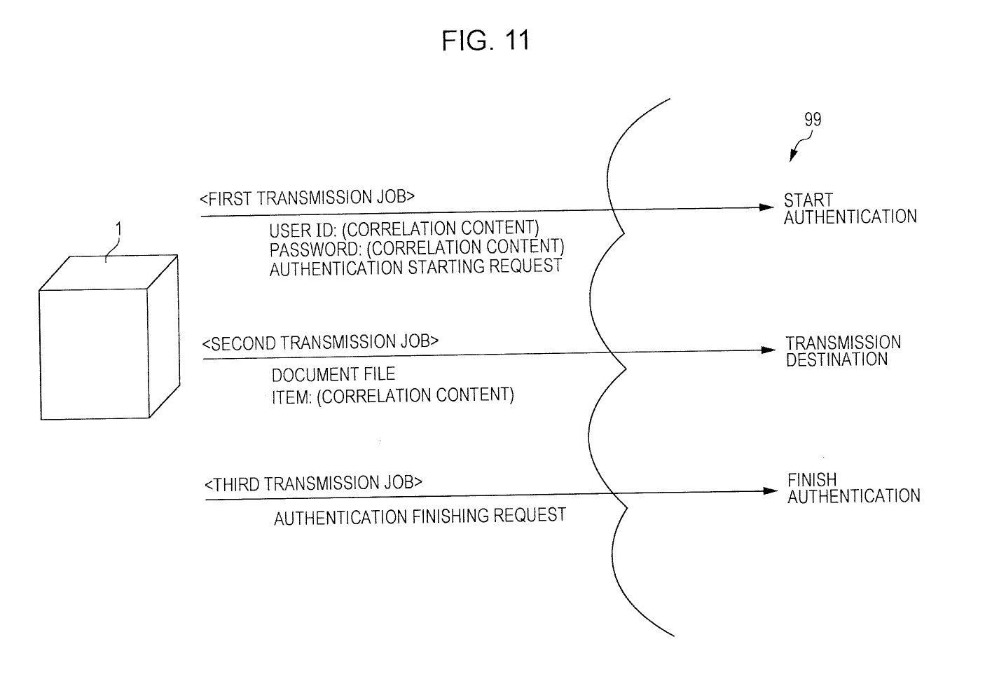

In the case where the page 30 involves a transition as illustrated in FIG. 5 discussed above, the information processing apparatus 1 may execute the plural transmission jobs in order as illustrated in FIG. 11. When the first transmission job is executed, the information processing apparatus 1 transmits a character string correlated as the user ID, a character string correlated as the password, and an authentication starting request to the external system 99. When the second transmission job is executed, the information processing apparatus 1 transmits a document file to the external system 99 as in the distribution job illustrated in FIG. 10. When the third transmission job is executed, the information processing apparatus 1 transmits an authentication finishing request to the external system 99. This enables the information processing apparatus 1 to transmit a document file etc. to the external system 99 as in the case illustrated in FIG. 5 discussed above.

Returning to the description of FIG. 2, after the transmission of the document file, the result determination section 25 determines on the basis of a response from the external system 99 whether or not the document file has been successfully transmitted (which is a function as an example of a determination unit). In the case where a transmission complete message is displayed on the page based on the HTML file transmitted from the external system 99 after the transmission of the document file (see FIG. 5), for example, it is determined that the document file has been successfully transmitted. In the case where there is no response from the external system 99 or in the case where a transmission failure message is displayed on the page, for example, it is determined that the transmission of the document file has failed.

The update monitoring section 27 detects update of the HTML file held by the external system 99, and notifies the accessing section 23 in the case where update is detected (which is a function as an example of a detection unit). For example, layout information on the HTML file which is acquired by the page acquisition section 12 discussed above and from which the transmission destination information and the item information are extracted by the setting screen configuration section 13 is stored in the storage section 2. The update monitoring section 27 compares the layout information stored in the storage section 2 and the layout of the HTML file held by the external system 99 each time a distribution job is executed to detect any difference therebetween. The layout information is Document Object Model (DOM) information, for example.

In the case where update of the HTML file held by the external system 99 is detected, execution of the distribution job is suspended. Execution of the distribution job is resumed in the case where a page based on the updated HTML file is displayed on the display section 3 and the user determines that transmission will not be affected and inputs an instruction for resumption using the operating section 4, for example.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a holding unit that holds information for use during transmission including transmission destination information, item information, and correspondence information, the transmission destination information and the item information being acquired from page display information for displaying a page and transmitting document information at a designated location to a transmission destination determined in advance together with a character string or a value input in correspondence with an item to be displayed on the page, the transmission destination information representing the transmission destination, the item information representing the item, and the correspondence information pertaining to the character string or the value corresponding to the item; and
a transmission unit that transmits the document information to the transmission destination together with the character string or the value correlated with the item on a basis of the information for use during transmission.

2. The information processing apparatus according to claim 1,
wherein the information for use during transmission further includes transition information transmitted in accordance with the page display information for displaying another page from which it is possible to make a transition to the page or to which it is possible to make a transition from the page, and
the transmission unit transmits the transition information to the transmission destination before or after the document information on a basis of the information for use during transmission.

3. The information processing apparatus according to claim 1,
wherein the correspondence information represents correlation between a character string or a value added in advance to the document information and the item.

4. The information processing apparatus according to claim 1, further comprising:
a detection unit that detects a difference between the page display information from which the transmission destination information and the item information have been acquired and the page display information held by the transmission destination.

5. The information processing apparatus according to claim 1, further comprising:
a determination unit that determines on a basis of a response from the transmission destination whether or not the document information has been successfully transmitted.

6. An information processing apparatus comprising:
an acquisition unit that acquires transmission destination information and item information from page display information for displaying a page and transmitting document information at a designated location to a transmission destination determined in advance together with a character string or a value input in correspondence with an item to be displayed on the page, the transmission destination information representing the transmission destination and the item information representing the item;
a first generation unit that generates correspondence information pertaining to the character string or the value corresponding to the item; and
a second generation unit that generates information for use during transmission for transmitting the document information to the transmission destination together with the character string or the value correlated with the item, the information for use during transmission including the transmission destination information, the item information, and the correspondence information.

7. The information processing apparatus according to claim 6,
wherein the information for use during transmission further includes transition information transmitted in accordance with page display information for displaying another page from which it is possible to make a transition to the page or to which it is possible to make a transition from the page, the transition information being transmitted to the transmission destination before or after the document information.

8. The information processing apparatus according to claim 6, further comprising:
an addition unit that adds to the page display information region display information for displaying on the page a generation assist region for assisting generation of the correspondence information.

9. A non-transitory computer readable medium storing a program causing a computer to perform a process comprising:
holding information for use during transmission including transmission destination information, item information, and correspondence information, the transmission destination information and the item information being acquired from page display information for displaying a page and transmitting document information at a designated location to a transmission destination determined in advance together with a character string or a value input in correspondence with an item to be displayed on the page, the transmission destination information representing the transmission destination, the item information representing the item, and the correspondence information pertaining to the character string or the value corresponding to the item; and
transmitting the document information to the transmission destination together with the character string or the value correlated with the item on a basis of the information for use during transmission.

10. A non-transitory computer readable medium storing a program causing a computer to perform a process comprising:
acquiring transmission destination information and item information from page display information for displaying a page and transmitting document information at a designated location to a transmission destination determined in advance together with a character string or a value input in correspondence with an item to be displayed on the page, the transmission destination information representing the transmission destination and the item information representing the item;
generating correspondence information pertaining to the character string or the value corresponding to the item; and
generating information for use during transmission for transmitting the document information to the transmission destination together with the character string or the value correlated with the item, the information for use during transmission including the transmission destination information, the item information, and the correspondence information.
